(19) United States
(12) Patent Application Publication
(10) Pub. No.: US 2019/0155941 A1
(43) Pub. Date: May 23, 2019

(54) GENERATING ASSET LEVEL CLASSIFICATIONS USING MACHINE LEARNING

(71) Applicant: International Business Machines Corporation, Armonk, NY (US)

(72) Inventors: Manish A. Bhide, Hyderabad (IN); Jonathan Limburn, Southampton (GB); William Bryan Lobig, Trabuco Canyon, CA (US); Paul Taylor, Redwood City, CA (US)

(21) Appl. No.: 15/820,117

(22) Filed: Nov. 21, 2017

(51) Int. Cl. G06F 17/30; G06N 5/04; G06N 99/00

(52) U.S. Cl. CPC G06F 17/30598; G06N 99/005; G06N 5/046

(57) ABSTRACT

Systems, methods, and computer program products to perform an operation comprising receiving a plurality of assets from a data catalog and a respective plurality of classifications applied to each asset in the data catalog, extracting, for a plurality of features, feature data from the plurality of assets and the plurality of asset classifications, generating a feature vector based on the extracted feature data; and generating, by a machine learning (ML) algorithm and based on the feature vector, a first classification rule specifying a condition for applying a first classification of the plurality of classifications to a first asset of the plurality of assets.

### BACKGROUND

The present disclosure relates to data governance. More specifically, the present disclosure relates to generating asset level classifications using machine learning.

Data governance relates to the overall management of the availability, usability, integrity, and security of data used in an enterprise. Data governance includes rules or policies used to restrict access to data classified as belonging to a particular asset level classification. For example, a database column storing social security numbers may be tagged with an asset level classification of “confidential,” while a rule may restrict access to data tagged with the confidential asset level classification to a specified user or group of users. Asset level classifications may be specified manually by a user, or programmatically generated by a system based on a classification rule (or policy). However, as new assets are added, existing rules may need to change in light of the new assets. Similarly, new rules may need to be defined in light of the new assets. With asset types numbering in the millions or more, it is not possible for users to decide what new rules should be defined, or what existing rules need to be modified. Similarly, the users cannot determine whether existing asset classifications should be modified for a given asset, or whether to tag assets with new classifications.

### SUMMARY

According to one embodiment of the present disclosure, a method comprises receiving a plurality of assets from a data catalog and a respective plurality of classifications applied to each asset in the data catalog, extracting, for a plurality of features, feature data from the plurality of assets and the plurality of asset classifications, generating a feature vector based on the extracted feature data, and generating, by a machine learning (ML) algorithm and based on the feature vector, a first classification rule specifying a condition for applying a first classification of the plurality of classifications to a first asset of the plurality of assets.

In another embodiment, a system comprises a processor and a memory containing a program which when executed by the processor performs an operation comprising receiving a plurality of assets from a data catalog and a respective plurality of classifications applied to each asset in the data catalog, extracting, for a plurality of features, feature data from the plurality of assets and the plurality of asset classifications, generating a feature vector based on the extracted feature data, and generating, by a machine learning (ML) algorithm and based on the feature vector, a first classification rule specifying a condition for applying a first classification of the plurality of classifications to a first asset of the plurality of assets.

In another embodiment, a computer program product comprises a non-transitory computer readable medium storing instructions, which, when executed by a processor, performs an operation comprising receiving a plurality of assets from a data catalog and a respective plurality of classifications applied to each asset in the data catalog, extracting, for a plurality of features, feature data from the plurality of assets and the plurality of asset classifications, generating a feature vector based on the extracted feature data, and generating, by a machine learning (ML) algorithm and based on the feature vector, a first classification rule specifying a condition for applying a first classification of the plurality of classifications to a first asset of the plurality of assets.

### BRIEF DESCRIPTION OF THE SEVERAL VIEWS OF THE DRAWINGS

FIG. 1 illustrates a system for generating asset level classifications using machine learning, according to one embodiment.

FIG. 2 illustrates a method to generate asset level classifications using machine learning, according to one embodiment.

FIG. 3 illustrates a method to define features, according to one embodiment.

FIG. 4 is a flow chart illustrating a method to extract feature data to generate a feature vector and generate a machine learning model specifying one or more classification rules, according to one embodiment.

FIG. 5 is a flow chart illustrating a method to process generated classification rules for assets having user-defined classifications, according to one embodiment.

FIG. 6 is a flow chart illustrating a method to process generated classification rules for assets having programmatically generated classifications based on programmatically generated classification rules, according to one embodiment.

FIG. 7 illustrates an example system which generates asset level classifications using machine learning, according to one embodiment.

### DETAILED DESCRIPTION

Embodiments disclosed herein leverage machine learning (ML) to generate new asset level classification rules and/or generate changes to existing asset level classification rules. Generally, embodiments disclosed herein provide different attributes, or features, to a ML algorithm which generates a feature vector. The ML algorithm then uses the feature vector to generate one or more asset level classification rules. Doing so allows existing and new assets to be programmatically tagged with the most current and appropriate asset level classifications.

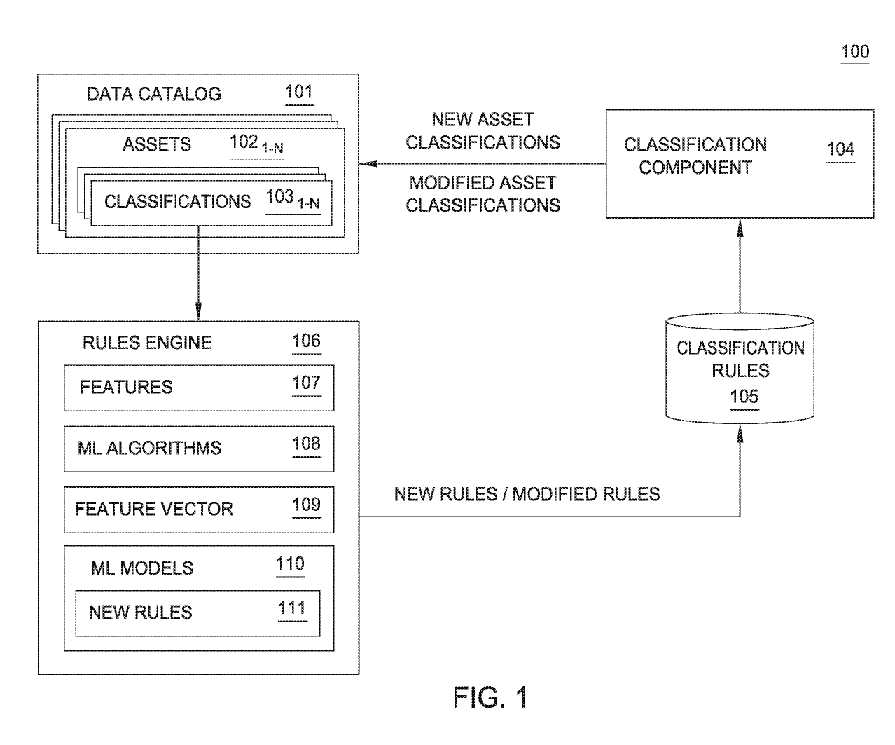

FIG. 1 illustrates a system 100 for generating asset level classifications using machine learning, according to one embodiment. As shown, the system 100 includes a data catalog 101, a classification component 104, a data store of classification rules 105, and a rules engine 106. The data catalog 101 stores metadata describing a plurality of assets 102_{1-N} in an enterprise. The assets 102_{1-N} are representative of any type of software resource, including, without limitation, databases, tables in a database, a column in a database table, a file in a filesystem, and the like. As shown, each asset 102_{1-N} may be tagged (or associated with) one or more asset level classifications 103_{1-N}. The asset level classifications 103_{1-N} include any type of classification describing a given asset, including, without limitation, “confidential”, “personally identifiable information”, “finance”, “tax”, “protected health information”, and the like. Generally, the assets 102_{1-N} are tagged in with classifications 103_{1-N} accordance with one or more classification rules 105. The classification rules 105 specify conditions for applying a classification 103_{N} to the assets 102_{1-N}. For example, a rule in the classification rules 105 may specify to tag an asset 102_{1-N} with a classification 103_{N} of “personally identifiable information” if the metadata of the asset 102_{1-N} specifies the asset 102_{1-N} includes database column types of “person name” and “zip code.” As another example, a rule in the classification rules 105 may specify to tag an asset 102_{1-N} with a classification of “confidential” if the asset 102_{1-N} is of a “patent disclosure” type. Generally, any number and type of rules of any type of complexity can be stored in the classification rules 105. The classification component 104 may programmatically generate and apply classifications 103_{1-N} to assets 102_{1-N} based on the classification rules 105 and one or more attributes of the assets 102_{1-N}. However, users may also manually tag assets 102_{1-N} with classifications 103_{1-N} based on the classification rules 105.

The rules engine 106 is configured to generate new classification rules 111 for storage in the classification rules 105 using machine learning. The new rules 111 are also representative of modifications to existing rules in the classification rules 105. As shown, the rules engine 106 includes a data store of features 107, one or more machine learning algorithms 108, one or more feature vectors 109, and one or more machine learning models 110. The features 107 are representative of features (or attributes) of the assets 102_{1-N} and/or the classifications 103_{1-N}. Stated differently, a feature is an individual measurable property or characteristic of the data catalog 101, including the assets 102_{1-N} and/or the classifications 103_{1-N}. Example features 107 include, without limitation, a classification 103_{N} assigned to an asset 102_{N}, data types (e.g., integers, binary data, files, etc.) of assets 102_{1-N}, tags that have been applied to the assets 102_{1-N} (e.g., salary, accounting, etc.), and sources of the assets 102_{1-N}. In at least one embodiment, a user defines the features 107 for use by the ML algorithms 108. Generally, a machine learning algorithm is a form of artificial intelligence which allows software to become more accurate in predicting outcomes without being explicitly programmed to do so. Examples of ML algorithms 108 include, without limitation, decision tree classifiers, support vector machines, artificial neural networks, and the like. The use of any particular ML algorithm 108 as a reference example herein should not be considered limiting of the disclosure, as the disclosure is equally applicable to any type of machine learning algorithm configured to programmatically generate classification rules 105.

Generally, a given ML algorithm 108 receives the features 107, the assets 102_{1-N}, and the classifications 103_{1-N} as input, and generates a feature vector 109 that identifies patterns or other trends in the received data. For example, if the features 107 specified 100 features, the feature vector 109 would include data describing each of the 100 features relative to the assets 102_{1-N} and/or the classifications 103_{1-N}. For example, the feature vector 109 may indicate that out of 1,000 example assets 102_{1-N} tagged with a “personally identifiable information” classification 103_{N}, 700 of the 1,000 assets 102_{1-N} had data types of “person name” and “zip code”. In some embodiments, the feature vectors 109 may be generated by techniques other than via the ML algorithms 108. In such embodiments, the feature vectors 109 may be defined based on an analysis of the data in the assets 102_{1-N} and/or the classifications 103_{1-N}. The ML algorithms 108 may then use the feature vector 109 to generate one or more ML models 110 that specify new rules 111. For example, a new rule 111 generated by the ML algorithms 108 and/or the ML models 110 may specify: “if an asset contains a column of type ‘employee ID’ and a column of type ‘salary’ and the columns ‘employeeID’ and ‘salary’ are of type ‘integer’, tag the asset with a classification of ‘confidential’”. The preceding rule is an example of a format the new rules 111 may take. However, the new rules may be formatted according to any predefined format, and the ML algorithms 108 and/or ML models 110 may be configured to generate the new rules 111 according to any format.

The rules engine 106 may then store the newly generated rules 111 in the classification rules 105. However, in some embodiments, the rules engine 106 processes the new rules 111 differently based on whether a user has provided an asset level classification 103_{N} for a given asset 102_{1-N} in the data catalog, and whether the classification component 104 programmatically generated a classification 103_{N} for a given asset 102_{1-N} based on the a rule in the classification rules 105 that was programmatically generated by the rules engine 106. If the user has previously provided asset level classifications 103_{N}, the rules engine 106 searches for a matching (or substantially similar) rule in the classification rules 105 (e.g., based on matching of terms in each rule, a score computed for the rule, etc.). If a match exists, the rules engine 106 compares the identified rule(s) to the new rule 111. If the rules are the same, the rules engine 106 discards the rule. If the identified rules are similar, the rules engine 106 may output the new rule 111 to a user (e.g., a data steward) as a suggestion to modify the existing rule in the classification rules 105. If there is no matching rule, the rules engine 106 may optionally present the new rule 111 to the user for approval prior to storing the new rule 111 in the classification rules 105.

If the classification component 104 has previously generated a classification 103_{1-N} based on a classification rule 105 generated by the rules engine 106, the rules engine 106 compares the new rule 111 to the classification rule 105 previously generated by the rules engine 106. If the new rule 111 is the same as the classification rule 105 previously generated by the rules engine 106, the rules engine 106 ignores and discards the new rule 111. If the comparison indicates a difference between the new rule 111 and the existing classification rule 105 previously generated by the rules engine 106, the rules engine 106 may output the new rule 111 as a suggested modification to the existing classification rule 105. The user may then approve the new rule 111, which replaces the existing classification rule 105. The user may also decline to approve the new rule 111, leaving the existing classification rule 105 unmodified. In some embodiments, the rules engine 106 applies heuristics to the new rule 111 before suggesting the new rule 111 as a modification to the existing classification rule 105. For example, if the difference between the new rule 111 and the existing classification rule 105 relates only to the use of data types (or other basic information such as confidence levels or scores), the rules engine 106 may determine that the difference is insignificant, and refrain from suggesting the new rule 111 to the user. More generally, the rules engine 106 may determine whether differences between rules are significant or insignificant based on the type of rule, the data types associated with the rule, and the like.

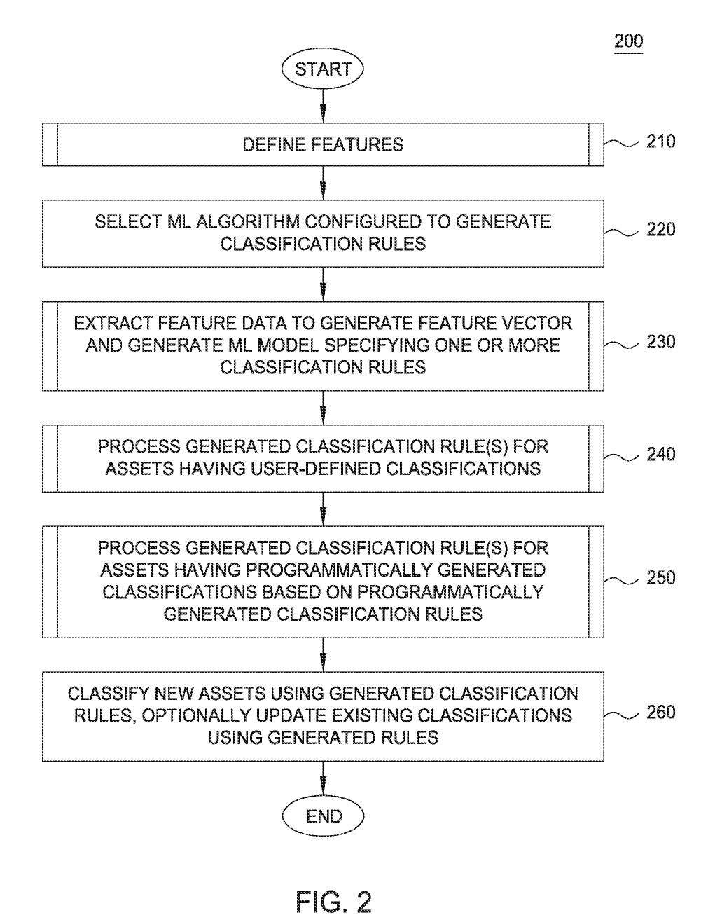

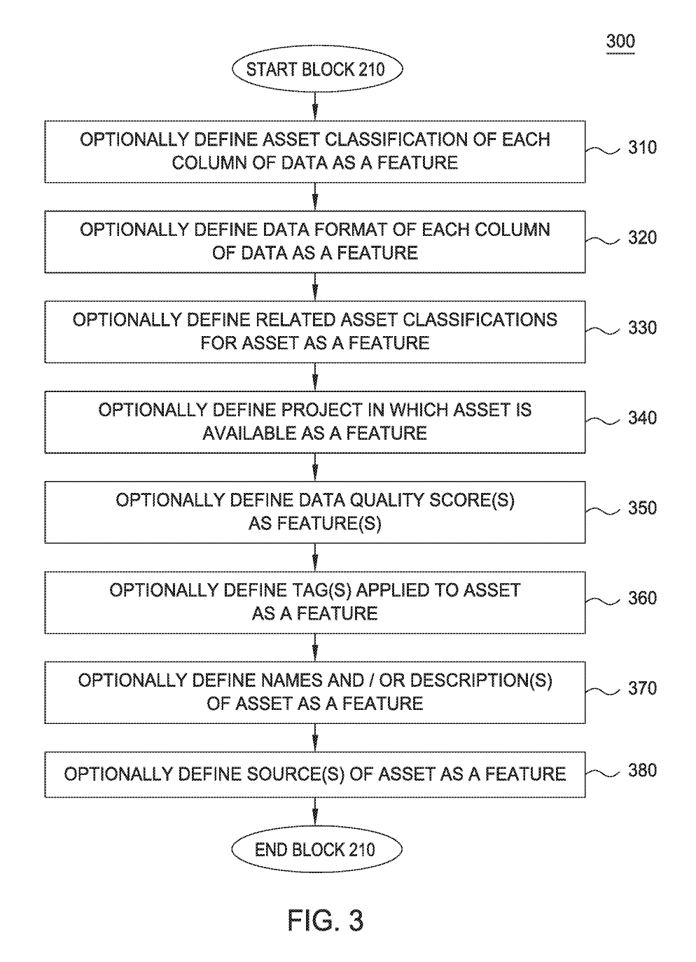

FIG. 2 illustrates a method 200 to generate asset level classifications using machine learning, according to one embodiment. As shown, the method 200 begins at block 210, described in greater detail with reference to FIG. 3, where one or more features 107 of the assets 102_{1-N} and/or the classifications 103_{1-N} are defined. Generally, the features 107 reflect any type of attribute of the assets 102_{1-N} and/or the classifications 103_{1-N}, such as data types, data formats, existing classifications 103_{1-N} applied to an asset 102_{1-N}, sources of the assets 102_{1-N}, names of the assets 102_{1-N}, and other descriptors of the assets 102_{1-N}. In one embodiment, a user defines the features 107. In another embodiment, the rules engine 106 is included with one or more predefined features 107. At block 220, the rules engine 106 and/or a user selects an ML algorithm 108 configured to generate classification rules. As previously stated, any type of ML algorithm 108 can be selected, such as decision tree based classifiers, support vector machines, artificial neural networks, and the like.

At block 230, the rules engine 106 leverages the selected ML algorithm 108 to extract feature data from the existing assets 102_{1-N} and/or the classifications 103_{1-N} in the catalog 101 to generate the feature vector 109 and generate one or more ML models 110 specifying one or more new classification rules, which may then be stored in the classification rules 105. Generally, at block 230, the ML algorithm 108 is provided the data describing assets 102_{1-N} and the classifications 103_{1-N} from the catalog 101, which extracts feature values corresponding to the features defined at 210. As previously indicated, however, in some embodiments, the feature vector 109 is generated without using the ML algorithm 108, e.g. via analysis and extraction of data describing the assets 102_{1-N} and/or the classifications 103_{1-N} in the catalog 101. For example, if the features 107 include a feature of “asset type”, the feature vector 109 would reflect each different type of asset in the assets 102_{1-N}, as well as a value reflecting how many assets 102_{1-N} are of each corresponding asset type. Based on the generated feature vector 109, the selected ML algorithm 108 may then generate a ML model 110 specifying one or more new classification rules.

At block 240, the rules engine 106 processes the new classification rules generated at block 230 if an asset 102_{1-N} in the catalog 101 has been tagged with a classification 103_{1-N} by a user. Generally, the rules engine 106 identifies existing rules in the classification rules 105 that are similar to (or match) the new rules generated at block 230, discarding those that are duplicates, suggesting modifications to existing rules to a user, and storing new rules in the classification rules 105. At block 250, the rules engine 106 processes the new classification rules generated at block 230 if an asset 102_{1-N} has been tagged by the classification component 104 with a classification 103_{1-N} based on a classification rule 105 generated by the rules engine 106 (or some other programmatically generated classification rule 105). Generally, at block 250, the rules engine 106 searches for existing rules in the classification rules 105 that match the rules generated at block 230. If an exact match exists, the rules engine 106 discards the new rule. If a similar rule exists in the classification rules 105, the rules engine 106 outputs the new and existing rule to the user, suggesting that the user accept the new rule as a modification to the existing rule. If the rule is a new rule, the rules engine 106 adds the new rule to the classification rules 105. In some embodiments, a given asset 102_{N} may meet the criteria defined at blocks 240 and 250. Therefore, in such cases, the methods 400 and 500 are executed for the newly generated rules.

At block 260, the classification component 104 tags new assets 102_{1-N} added to the catalog 101 with one or more classifications 103_{1-N} based on the rules generated at block 230 and/or updates existing classifications 103_{1-N} based on the rules generated at block 230. Doing so improves the accuracy of classifications 103_{1-N} programmatically applied to assets 102_{1-N} based on the classification rules 105. Furthermore, the steps of the method 200 may be periodically repeated to further improve accuracy of the ML models 110 and rules generated the ML algorithms 108, such that the ML algorithms 108 are trained on the previously generated ML models 110 and rules.

FIG. 3 illustrates a method 300 corresponding to block 210 to define features, according to one embodiment. As previously stated, in one embodiment, a user may manually define the features 107 which are provided to the rules engine 106 at runtime. In another embodiment, a developer of the rules engine 106 may define the features 107 as part of the source code of the rules engine 106. As shown, the method 200 begins at block 210, the classifications 103_{1-N} (e.g., the type) of each asset 102_{1-N} in the catalog 101 are defined as a feature 107. Often, asset level classifications 103_{1-N} depend on the classifications 103_{1-N} applied to each component of the asset 102_{1-N}. For example, if an asset 102_{N} includes a column of data of a type “person name” and a column of data of a type “health diagnosis”, the asset 102_{N} may need to be tagged with the asset level classification 103_{N} of “protected health information”. Similarly, if the asset 102_{N} includes a column of type “person name” and a column of type “zip code”, the asset 102_{N} may need to be tagged with the asset level classification 103_{N} of “personally identifiable information”.

At block 320, the data format the assets 102_{1-N} is optionally defined as a feature. Doing so allows the rules engine 106 and/or ML algorithms 108 to identify relationships between data formats and classifications 103_{N} for the purpose of generating classification rules. For example, if an asset 102_{N} includes many columns of data that are of a “binary” data format, these binary data columns may be of little use. Therefore, such an asset 102_{N} may be tagged with a classification 103_{N} of “non-productive data”, indicating a low level of importance of the data. As such, the rules engine 106 and/or ML algorithms 108 may generate a rule specifying to tag assets 102_{1-N} having columns of binary data with the classification of “non-productive data”.

At block 330, the classifications 103_{1-N} of a given asset is optionally defined as a feature 107. Often, existing classifications are related to other classifications. For example, if an asset 102_{N} is tagged with a “finance” classification 103_{N}, it may be likely to have other classifications 103_{1-N} that are related to the finance domain, such as “tax data” or “annual report”. By defining related classifications as a feature 107, such relationships may be extracted by the rules engine 106 and/or ML algorithms 108 from the catalog 101, facilitating the generation of classification rules 105 based on the same. At block 340, the project (or data catalog 101) in which an asset 102_{N} belongs to is optionally defined as a feature 107. Generally, data assets 102_{1-N} that are in the same project (or data catalog 101) are often related to each other. Therefore, if a project (or the data catalog 101) contains many assets 102_{1-N} that are classified with a classification 103_{N} of “confidential”, it is likely that a new asset 102_{N} added to the catalog 101 should likewise be tagged with a classification 103_{N} of “confidential”. During machine learning, the ML algorithms 108 and/or rules engine 106 may determine the degree to which these relationships matter, and generate classification rules 105 accordingly.

At block 350, the data quality score of an asset 102_{1-N} (or a component thereof) is optionally defined as a feature 107. Generally, the data quality score is a computed value which reflects the degree to which data values for a given column of an asset 102_{1-N} satisfy one or more criteria. For example, a first criterion may specify that a phone number must be formatted according to the format “xxx-yyy-zzzz”, and the data quality score reflects a percentage of values stored in the column having the required format. The rules engine 106 may classify assets 102_{1-N} having low quality scores with a classification 103_{N} of “review” to trigger review by a user. At block 360, the tags applied to an asset are optionally defined as a feature 107. Generally, a tag is a metadata attribute which describes an asset 102_{1-N}. For example, a tag may identify an asset 102_{N} as a “salary database”, “patent disclosure database”, and the like. By analyzing the tags of an asset 102_{N}, the rules engine 106 and/or the ML algorithms 108 may generate classification rules 105 reflecting the relationships between the tags and the classifications 103_{1-N} of the asset 102_{N}. For example, such a classification rule 105 may specify to apply a classification 103_{N} to the “salary database” and the “patent disclosure database”.

At block 370, the name and/or textual description of an asset 102_{N} is optionally defined as a feature 107. The name may also include bigrams and trigrams formed using the name of the asset 102_{N}. The description may also include bigrams and trigrams that are formed using the description of the asset 102_{N}. Often, the name and/or textual description of an asset 102_{1-N} has a role in the classifications 103_{1-N} applied to the asset 102_{1-N}. For example, the description of an asset 102_{1-N} includes the words “social security number”, it is likely that a classification 103_{N} of “confidential” should be applied to the asset 102_{1-N}. As such, the rules engine 106 and/or ML algorithms 108 may identify such names and/or descriptions, and generate classification rules 105 accordingly. At block 380, the source of an asset 102_{1-N} is optionally defined as a feature 107. For example, an asset 102_{1-N} may have features similar to the features in a group of assets 102_{1-N} to which it belongs. As such, the rules engine 106 and/or the ML algorithms 108 may generate classification rules 105 reflecting the classifications 103_{1-N} of other assets in a group of assets 102_{1-N}.

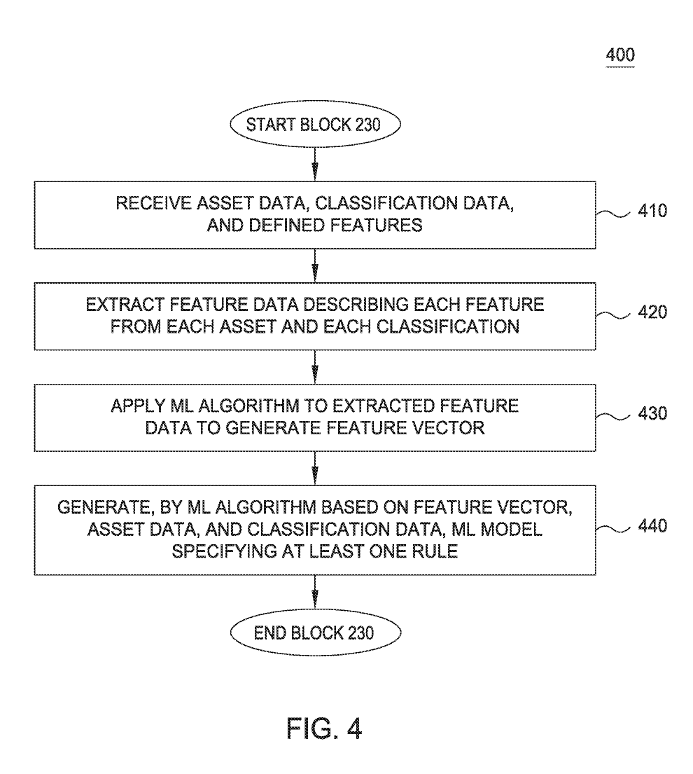

FIG. 4 is a flow chart illustrating a method 400 corresponding to block 240 to extract feature data to generate a feature vector and generate a machine learning model specifying one or more classification rules, according to one embodiment. As shown, the method 400 begins at block 410, where the rules engine 106 receives data describing the assets 102_{1-N} and the classifications 103_{1-N} from the data catalog 101 and the features 107 defined at block 210. At block 420, the rules engine 106 extracts feature data describing each feature 107 from each asset 102_{1-N} and/or each classification 103_{1-N}. At block 430, the ML algorithm 108 is applied to the extracted feature data to generate a feature vector 109. However, as previously indicated, the rules engine 106 may generate the feature vector 109 without applying the ML algorithm 108. In such embodiments, the rules engine 106 analyzes the extracted data from the catalog 101 and generates the feature vector 109 based on the analysis of the extracted data. At block 440, the rules engine 106 generates an ML model 110 specifying at least one new rule 111 based on the feature vector 109 and the data describing the assets 102_{1-N} and the classifications 103_{1-N} from the data catalog 101.

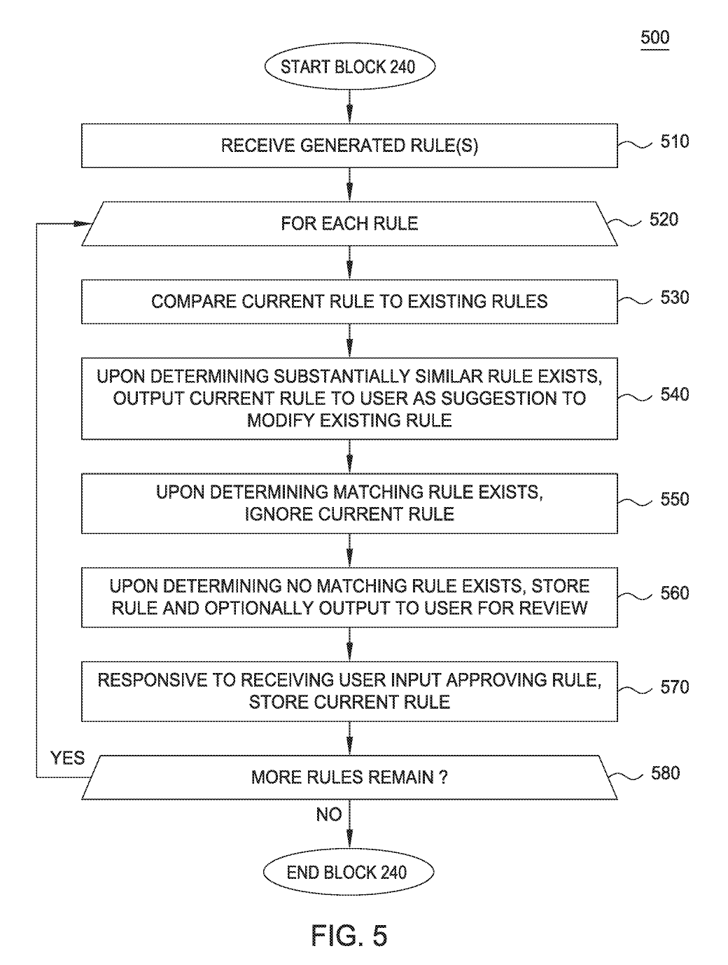

FIG. 5 is a flow chart illustrating a method 500 corresponding to block 250 to process generated classification rules for assets having user-defined classifications, according to one embodiment. As shown, the method 500 begins at block 510, where the rules engine 106 receives the new classification rules 111 generated at block 240. At block 520, the rules engine 106 executes a loop including blocks 530-580 for each classification rule received at block 510. At block 530, the rules engine 106 compares the current classification rule to the existing rules that were previously generated by the rules engine 106 in the classification rules 105. At block 540, the rules engine 106 identifies a substantially similar rule to the current rule (e.g., based on a number of matching terms in the rules exceeding a threshold), and outputs the current and existing rule to a user as part of a suggestion to modify the existing rule. If the user accepts the suggestion, the current rule replaces the existing rule in the classification rules 105. At block 550, the rules engine 106 ignores the current rule upon determining a matching rule exists in the classification rules 105, thereby refraining from saving a duplicate rule in the classification rules 105.

At block 560, upon determining a matching or substantially similar rule does not exist in the classification rules 105, the rules engine 106 stores the current rule in the classification rules 105. The rules engine 106 may optionally present the current rule to the user for approval before storing the rule. At block 570, the rules engine 106 stores the current rule responsive to receiving user input approving the current rule. At block 580, the rules engine 106 determines whether more rules remain. If more rules remain, the rules engine 106 returns to block 520. Otherwise, the method 500 ends.

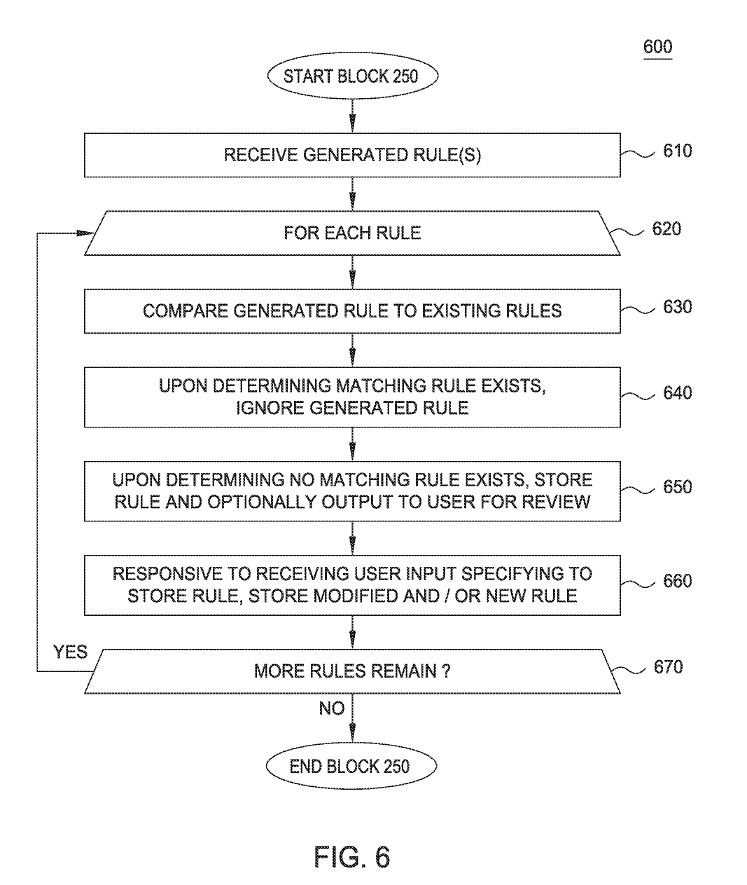

FIG. 6 is a flow chart illustrating a method 600 corresponding to block 260 to process generated classification rules for assets having programmatically generated classifications based on programmatically generated classification rules, according to one embodiment. As shown, the method 600 begins at block 610, where the rules engine 106 receives the new classification rules 111 generated at block 240. At block 620, the rules engine 106 executes a loop including blocks 630-670 for each classification rule received at block 610. At block 630, the rules engine 106 compares the current classification rule to the existing rules in the classification rules 105. At block 640, the rules engine 106 ignores the current rule upon determining a matching rule exists in the classification rules 105, thereby refraining from saving a duplicate rule in the classification rules 105. At block 650, the rules engine 106 stores the current rule upon determining a matching rule does not exist in the classification rules 105. However, the rules engine 106 may optionally present the current rule to the user before storing the rule. At block 660, the rules engine 106 stores the current rule responsive to receiving user input approving the current rule. At block 670, the rules engine 106 determines whether more rules remain. If more rules remain, the rules engine 106 returns to block 620. Otherwise, the method 600 ends.

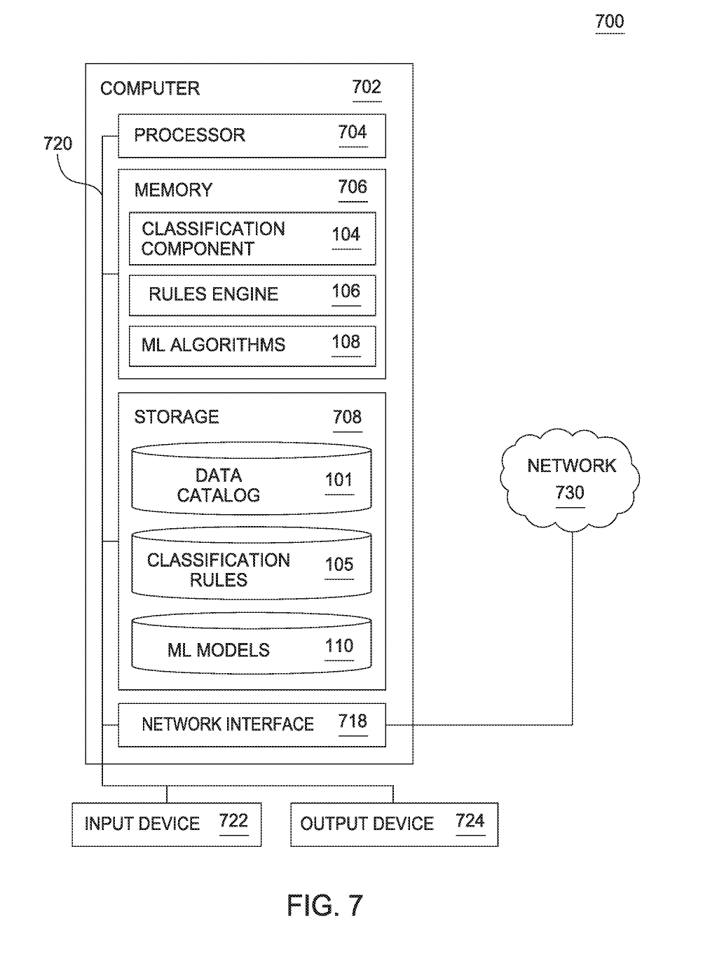

FIG. 7 illustrates an example system 700 which generates asset level classifications using machine learning, according to one embodiment. The networked system 700 includes a server 101. The server 101 may also be connected to other computers via a network 730. In general, the network 730 may be a telecommunications network and/or a wide area network (WAN). In a particular embodiment, the network 730 is the Internet.

The server 101 generally includes a processor 704 which obtains instructions and data via a bus 720 from a memory 706 and/or a storage 708. The server 101 may also include one or more network interface devices 718, input devices 722, and output devices 724 connected to the bus 720. The server 101 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 704 is a programmable logic device that performs instruction, logic, and mathematical processing, and may be representative of one or more CPUs. The network interface device 718 may be any type of network communications device allowing the server 101 to communicate with other computers via the network 730.

The storage 708 is representative of hard-disk drives, solid state drives, flash memory devices, optical media and the like. Generally, the storage 708 stores application programs and data for use by the server 101. In addition, the memory 706 and the storage 708 may be considered to include memory physically located elsewhere; for example, on another computer coupled to the server 101 via the bus 720.

The input device 722 may be any device for providing input to the server 101. For example, a keyboard and/or a mouse may be used. The input device 722 represents a wide variety of input devices, including keyboards, mice, controllers, and so on. Furthermore, the input device 722 may include a set of buttons, switches or other physical device mechanisms for controlling the server 101. The output device 724 may include output devices such as monitors, touch screen displays, and so on.

As shown, the memory 706 contains the classification component 104, rules engine 106, and ML algorithms 108, each described in greater detail above. As shown, the storage 708 contains the data catalog 101, the classification rules 105, and the ML models 110, each described in greater detail above. Generally, the system 700 is configured to implement all functionality, methods, and techniques described herein with reference to FIGS. 1-6.

Advantageously, embodiments disclosed herein leverage machine learning to generate classification rules for applying classifications to assets in a data catalog. By programmatically generating accurate classification rules, the classifications may be programmatically applied to the assets with greater accuracy.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the foregoing, reference is made to embodiments presented in this disclosure. However, the scope of the present disclosure is not limited to specific described embodiments. Instead, any combination of the recited features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the recited aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications or related data available in the cloud. For example, the rules engine 106 could execute on a computing system in the cloud and generate classification rules 105. In such a case, the rules engine 106 could store the generated classification rules 105 at a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving a plurality of assets from a data catalog and a respective plurality of classifications applied to each asset in the data catalog;
extracting, for a plurality of features, feature data from the plurality of assets and the plurality of asset classifications;
generating a feature vector based on the extracted feature data; and
generating, by a machine learning (ML) algorithm and based on the feature vector, a first classification rule specifying a condition for applying a first classification of the plurality of classifications to a first asset of the plurality of assets.

2. The method of claim 1, further comprising:
determining that a second classification of the plurality of classifications applied to the first asset was applied to the first asset by a user;
identifying a second classification rule generated by the ML algorithm;
determining that a number of terms present in the first classification rule and the second classification rule exceeds a threshold; and
outputting the first and second classification rules to the user with an indication specifying to replace the second classification rule with the first classification rule.

3. The method of claim 1, further comprising:
storing the first classification rule;
determining a new asset has been added to the data catalog;
determining that the new asset satisfies the condition specified in the first classification rule; and
programmatically applying the first classification to the new asset.

4. The method of claim 1, further comprising:
determining that a second classification of the plurality of classifications was programmatically applied to the first asset based on a second classification rule generated by the ML algorithm;
determining that a number of terms present in the first classification rule and the second classification rule exceeds a threshold; and
outputting the first and second classification rules to a user with an indication specifying to replace the second classification rule with the first classification rule.

5. The method of claim 1, wherein the ML algorithm comprises one of: (i) a decision tree based classifier, (ii) a support vector machine, and (iii) an artificial neural network, wherein the ML algorithm generates the feature vector.

6. The method of claim 1, wherein the plurality of features comprise: (i) the plurality of classifications, (ii) a type of each of the plurality of classifications, (iii) a data format of each of the plurality of assets, (iii) a relationship between two or more of the plurality of classifications, (iv) a project to which each of the plurality of assets belong, (v) a data quality score computed for each of the plurality of assets, (vi) a set of tags applied to each of the plurality of assets, (vii) a name of each of the plurality of assets, (viii), a textual description of each of the plurality of assets, and (ix) a group of assets comprising a subset of the plurality of assets.

7. The method of claim 1, wherein the plurality of assets comprise: (i) a database, (ii) files, (iii) columns in the database, and (iv) a table in the database.

8. A system, comprising:
a processor; and
a memory containing a program which when executed by the processor performs an operation comprising:
receiving a plurality of assets from a data catalog and a respective plurality of classifications applied to each asset in the data catalog;
extracting, for a plurality of features, feature data from the plurality of assets and the plurality of asset classifications;
generating a feature vector based on the extracted feature data; and
generating, by a machine learning (ML) algorithm and based on the feature vector, a first classification rule specifying a condition for applying a first classification of the plurality of classifications to a first asset of the plurality of assets.

9. The system of claim 8, the operation further comprising:
determining that a second classification of the plurality of classifications applied to the first asset was applied to the first asset by a user;
identifying a second classification rule generated by the ML algorithm;
determining that a number of terms present in the first classification rule and the second classification rule exceeds a threshold; and
outputting the first and second classification rules to the user with an indication specifying to replace the second classification rule with the first classification rule.

10. The system of claim 8, the operation further comprising:
storing the first classification rule;
determining a new asset has been added to the data catalog;
determining that the new asset satisfies the condition specified in the first classification rule; and
programmatically applying the first classification to the new asset.

11. The system of claim 8, the operation further comprising:
determining that a second classification of the plurality of classifications was programmatically applied to the first asset based on a second classification rule generated by the ML algorithm;
determining that a number of terms present in the first classification rule and the second classification rule exceeds a threshold; and
outputting the first and second classification rules to a user with an indication specifying to replace the second classification rule with the first classification rule.

12. The system of claim 8, wherein the ML algorithm comprises one of: (i) a decision tree based classifier, (ii) a support vector machine, and (iii) an artificial neural network, wherein the ML algorithm generates the feature vector.

13. The system of claim 8, wherein the plurality of features comprise: (i) the plurality of classifications, (ii) a type of each of the plurality of classifications, (iii) a data format of each of the plurality of assets, (iii) a relationship between two or more of the plurality of classifications, (iv) a project to which each of the plurality of assets belong, (v) a data quality score computed for each of the plurality of assets, (vi) a set of tags applied to each of the plurality of assets, (vii) a name of each of the plurality of assets, (viii), a textual description of each of the plurality of assets, and (ix) a group of assets comprising a subset of the plurality of assets.

14. The system of claim 8, wherein the plurality of assets comprise: (i) a database, (ii) files, (iii) columns in the database, and (iv) a table in the database.

15. A computer program product, comprising:
a computer-readable storage medium having computer-readable program code embodied therewith, the computer-readable program code executable by one or more computer processors to perform an operation comprising:
receiving a plurality of assets from a data catalog and a respective plurality of classifications applied to each asset in the data catalog;
extracting, for a plurality of features, feature data from the plurality of assets and the plurality of asset classifications;
generating a feature vector based on the extracted feature data; and
generating, by a machine learning (ML) algorithm and based on the feature vector, a first classification rule specifying a condition for applying a first classification of the plurality of classifications to a first asset of the plurality of assets.

16. The computer program product of claim 15, the operation further comprising:
determining that a second classification of the plurality of classifications applied to the first asset was applied to the first asset by a user;
identifying a second classification rule generated by the ML algorithm;
determining that a number of terms present in the first classification rule and the second classification rule exceeds a threshold; and
outputting the first and second classification rules to the user with an indication specifying to replace the second classification rule with the first classification rule.

17. The computer program product of claim 15, the operation further comprising:
storing the first classification rule;
determining a new asset has been added to the data catalog;
determining that the new asset satisfies the condition specified in the first classification rule; and
programmatically applying the first classification to the new asset.

18. The computer program product of claim 15, the operation further comprising:
determining that a second classification of the plurality of classifications was programmatically applied to the first asset based on a second classification rule generated by the ML algorithm;
determining that a number of terms present in the first classification rule and the second classification rule exceeds a threshold; and
outputting the first and second classification rules to a user with an indication specifying to replace the second classification rule with the first classification rule.

19. The computer program product of claim 15, wherein the ML algorithm comprises one of: (i) a decision tree based classifier, (ii) a support vector machine, and (iii) an artificial neural network, wherein the ML algorithm generates the feature vector.

20. The computer program product of claim 15, wherein the plurality of features comprise: (i) the plurality of classifications, (ii) a type of each of the plurality of classifications, (iii) a data format of each of the plurality of assets, (iii) a relationship between two or more of the plurality of classifications, (iv) a project to which each of the plurality of assets belong, (v) a data quality score computed for each of the plurality of assets, (vi) a set of tags applied to each of the plurality of assets, (vii) a name of each of the plurality of assets, (viii), a textual description of each of the plurality of assets, and (ix) a group of assets comprising a subset of the plurality of assets, wherein the plurality of assets comprise: (i) a database, (ii) files, (iii) columns in the database, and (iv) a table in the database.
